(19) United States
(12) Patent Application Publication
(10) Pub. No.: US 2007/0136600 A1
(43) Pub. Date: Jun. 14, 2007

(54) Document Verification System and Method of Use

(76) Inventors: Joseph N. Wilkinson, Mammoth Lakes, CA (US); Charles H. Foreman, Las Vegas, NV (US); Robert J. Palermo, Queensbury, NY (US)

Correspondence Address: GREENBERG TRAURIG, 3773 HOWARD HUGHES PARKWAY, SUITE 500 NORTH, LAS VEGAS, NV, 89169, US

(21) Appl. No.: 11/566,560

(22) Filed: Dec. 4, 2006

Related U.S. Application Data
(60) Provisional application No. 60/750,093, filed on Dec. 13, 2005.

(51) Int. Cl. H04L 9/00

(52) U.S. Cl. 713/176

(57) ABSTRACT

Described is a system and method of verifying documents for users possessing little or no document examination skill or experience. The system and method involve simple, secure, and expeditious means for determining the authenticity of identity or financial documents. In addition, users can submit documents of questionable authenticity to the appropriate authority.

### CROSS-REFERENCE TO RELATED APPLICATION

This application claims the benefit of Provisional Application Ser. No. 60/750,093 filed on Dec. 13, 2005 entitled “Identity and Financial Document Verification System,” and is related to copending U.S. patent application Ser. No. 11/080,916 filed on Mar. 14, 2005 entitled “Hologram Imaging Device and Method of Using Same.” The entireties of these applications are incorporated herein by reference for all purposes.

### FIELD OF THE INVENTION

The embodiments of the present invention relate generally to document verification systems, more specifically, to a document verification system and method using identity and financial documents.

### BACKGROUND

Various document verification systems have been in existence for years. In some systems, verifying a document typically requires an expert or a person trained in identifying, comparing and verifying documents to determine its authenticity. This can be both time consuming and cost prohibitive because of the extensive training or years of experience that is required. Automated or computerized verification systems, on the other hand, are quick and efficient at analyzing and verifying the authenticity of documents. However, these systems acquire and analyze existing security features, if any, without further validation or confirmation of the security features.

Thus, there exists a need for a document verification system that is not only low cost and easy to operate for users with little or no experience in examining and authenticating documents, but one that also focuses on identifying, comparing and verifying feature information associated with identity and financial documents.

### SUMMARY

The general purpose of the present invention, which will be described subsequently in greater detail, is to provide a new document verification system and method using identity and financial documents that has many novel features that result in a new document verification system and method, which is not anticipated, rendered obvious, suggested, or even implied by any prior art document verification systems and methods, either alone or in any combination thereof.

There has thus been outlined, rather broadly, the more important features of the embodiments of the present invention in order that the detailed description thereof may be better understood, and in order that the present contribution to the art may be better appreciated. There are additional features of the embodiments of the present invention that will be described hereinafter.

In this respect, before explaining the embodiments of the present invention it is to be understood that the embodiments of the present invention are not limited in their application to the details of construction and to the arrangements of the components set forth in the following description or illustrated in the drawings. The embodiments of the present invention are capable of being practiced and carried out in various ways. Also, it is to be understood that the phraseology and terminology employed herein are for the purpose of the description and should not be regarded as limiting.

Accordingly, one embodiment of the present invention is a document verification system, comprising: a storage device operable to store one or more validation documents; an acquisition device in communication with the storage device, the acquisition device operable to acquire at least one feature information from one or more unauthenticated documents and at least one feature information from the one or more validation documents; and a processing device in communication with the acquisition device and the storage device, the processing device operable to receive the at least one feature information from the one or more unauthenticated documents and the at least one feature information from the one or more validation documents. In another embodiment, the storage device, the acquisition device and the processing device may be integrated into a single unit.

A primary object of the present invention is to provide an identity and financial document verification system and method that overcomes the shortcomings of any prior art devices.

Another object of the present invention is to provide an identity and financial document verification system and method that provides users possessing little or no document examination experience with a simple, secure and expeditious system and method of determining the authenticity of a given identity or financial document and to submit documents of questionable authenticity to the appropriate authority.

Another object is to provide an identity and financial document verification system and method that provide secure storage for all documents and document feature information.

Another object is to provide an identity and financial document verification system and method that lead users through a step-by-step feature comparison of an unauthenticated document to a plurality of validation documents.

Another object is to provide an identity and financial document verification system and method that acquire visible document features or non-visible document features or both from a document.

Another object is to provide an identity and financial document verification system and method that acquire visible document features or non-visible document features or both from a document to a corresponding validation document.

Another object is to provide an identity and financial document verification system and method that secure and encrypt transport of document features (image and data) among all components of the identity and financial system and method and to other document systems and methods as needed.

Another object is to provide an identity and financial document verification system and method that provide electronic submission of a document to the appropriate document system and authority.

Another object is to provide an identity and financial document verification system and method that have the ability to distribute new information about counterfeit and invalidated documents.

Other objects and advantages of the present invention will become obvious to the reader and it is intended that these objects and advantages are within the scope of the present invention.

To the accomplishment of the above and related objects, the embodiments of the present invention may be configured in the form illustrated in the accompanying drawings, attention being called to the fact, however, that the drawings are illustrative only, and that changes may be made in the specific construction illustrated.

Other variations, embodiments and features of the present invention will become evident from the following detailed description, drawings and claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates an overview of a document verification system;

FIG. 2 illustrates a network of document storage devices; and

FIG. 3 illustrates a routing scenario among various document verification authorities.

### DETAILED DESCRIPTION

The detailed description below relates to a document verification system and method of use. However, it should be understood that the embodiments disclosed hereinafter are not limited in their application to the details of construction and/or the arrangements of the components. The embodiments of the present invention are capable of being practiced in various manners. Also, it should be understood that the phraseology and terminology employed herein are for the purpose of describing the embodiments of the present invention and are not intended to limit the scope of the invention in any way.

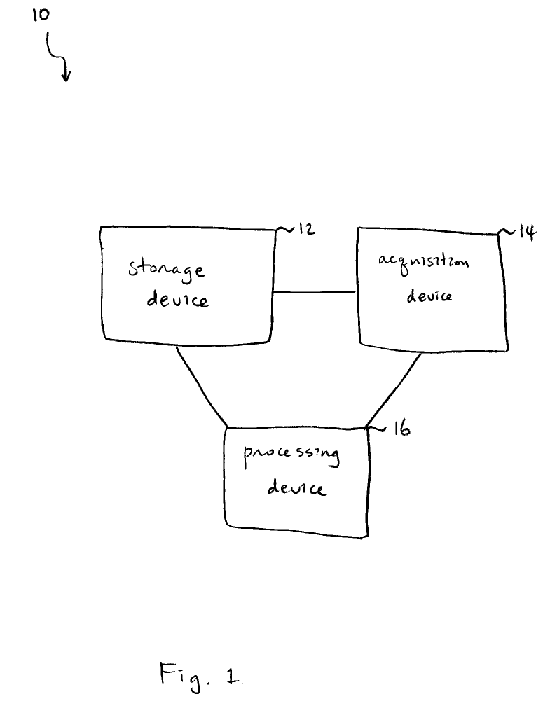

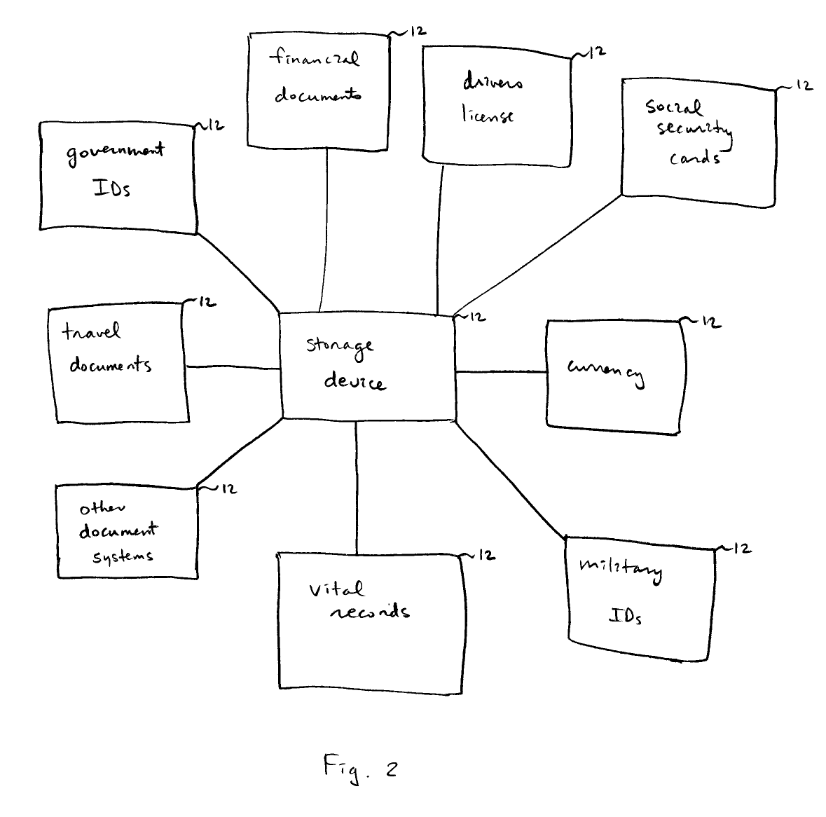

Initial reference is made to FIG. 1 illustrating a perspective view of a document verification system 10 according to one embodiment of the present invention. The document verification system 10 includes a storage device 12, which can store and maintain a plurality of validation documents, such as identity and financial documents containing genuine, counterfeit and exemplars. The identity and financial documents can be both domestic and foreign including without limitation, drivers' licenses, passports, government IDs, social security cards, travel documents, military IDs, birth records, health records, other vital records, currency, credit cards and travelers checks. Although illustrated as a single storage device 12, there can be a plurality of storage devices 12 in various locations for providing secured storage of the various identity and financial documents as shown in FIG. 2. The one or more storage devices 12 can be made accessible to a plurality of users by known security methods and systems. The one or more storage devices 12 can be configured on a PC or as a standalone unit or hosted on a server. The one or more storage devices 12 may be in the form of disc storage, tape storage, optical storage and other known methods and systems for storing data. The methods and systems of securing and transmitting information from and to the one or more storage devices 12 are commonly known and need not be described in further detail.

Returning now to FIG. 1, the document verification system 10 includes an acquisition device 14 in communication with the storage device 12, the acquisition device capable of acquiring a document's feature information, the acquisition process using known extraction hardware and software. The acquisition device 14 may be a camera, scanner, image capturing device or similar device. Like with the storage device 12, the acquisition device 14 can be configured on a PC or as a standalone unit or hosted on a server. The acquisition device 14 can also be configured by other known methods and systems. Ideally, the acquisition device 14 is integrated in a single unit with the storage device 12. An unauthenticated document can be manually entered or automatically detected by the acquisition device 14. The acquisition device 14 can also acquire or extract feature information from the validation documents in the storage device 12. The feature information can be either visible or non-visible document features including without limitation, printing process features, holograms, digital data such as magnetic stripe data, barcodes, RF data, optical data, image data, text data, physical characteristic data and user input data. Via a network configuration, the acquisition device 14 can also acquire or extract various feature information from other databases and other document systems. Furthermore, when the acquisition device 14 is presented with a document having new or previously unrecognized features, the acquisition device 14 is capable of being programmed to incorporate and acquire or extract the new or previously unrecognized features, this learning process can be automatic, manual or both. Like the storage device 12, the methods and systems of securing and transmitting information from and to the acquisition device 14 are commonly known and need not be described in further detail.

The document verification system 10 further includes a processing device 16, which can be configured on a PC or as a standalone unit or hosted on a server. The processing device 16 may be in the form of a computer processor, micro-computer, integrated circuit or similar processing means. The processing device 16 communicates and receives document feature information from both the acquisition device 14 and the storage device 12. Ideally, the processing device 16 can retrieve the feature information of the validation documents on the storage device 12. Otherwise, the processing device 16 can retrieve the feature information of the validation documents from the acquisition device 14 after the information has been acquired or extracted by the acquisition device 14. Ideally, the processing device 16 can be integrated into a single unit with either the storage device 12 or the acquisition device 14 or both. Like the storage device 12 and the acquisition device 14, the methods and systems of securing and transmitting information from and to the processing device 16 are commonly known and need not be described in further detail.

The processing device 16 further includes a verification application that provides users with step-by-step procedures related to a document verification process. Ideally, the document verification process involves comparing features acquired from an unauthenticated document with features acquired from the validation documents. In operation, the verification application initially retrieves validation documents that are stored on the storage device 12. If no validation documents exist on the storage device 12, the validation documents can be manually entered into the system. Once the validation documents are available, the verification application initiates the acquisition device 14 to acquire and extract feature information from the validation documents, if necessary. The extracted feature information can then be stored in a database on the storage device 12 for future reference. As previously described, if there are feature information that the acquisition device 14 is unfamiliar with, it can be programmed, via the verification application, to acquire or extract such unfamiliar feature information. The verification application will guide the user through this acquisition process if necessary. Ideally, there is no need for the verification application to initiate the acquisition or extraction process if feature information from the validation documents have been previously acquired and extracted or are already available on the storage device 12.

Once the feature information from the validation documents are made available, the verification application will ask for feature information from an unauthenticated document in making the necessary comparison. Like with the validation documents, the unauthenticated document can be pre-existing on the storage device 12 or can be manually entered into the system. Also, if the feature information of the unauthenticated document is readily available, the verification application will use it and make the comparison. If not, the verification application will initiate the acquisition device 14 and acquire or extract the feature information from the unauthenticated document in a similar fashion as with the validation document. As previously described, these document feature information can be visible or non-visible document features.

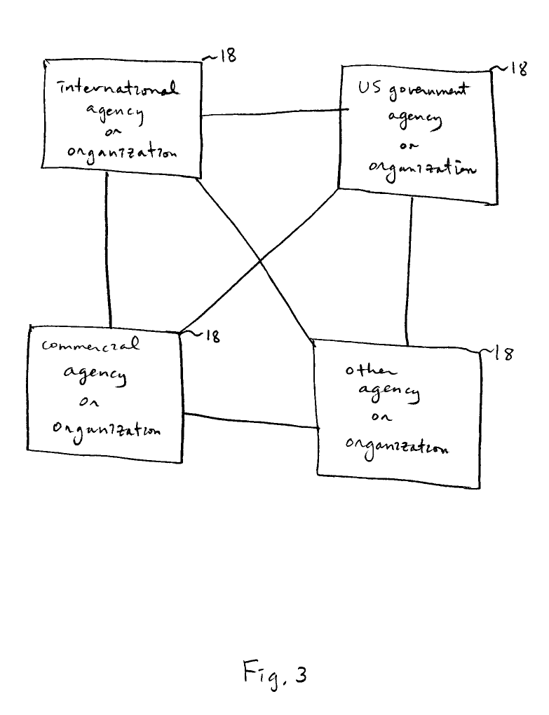

The standards of determining whether an unauthenticated document satisfies the document verification process can be decided by the processing device 16 or by a user. If the unauthenticated document satisfies the document verification process, meaning that the feature information from the unauthenticated document are substantially similar to the feature information from the validation documents, it will be determined to have been verified and validated. For instance, if there are 10 feature information available from the validation documents and 9 of those feature information can be found in the unauthenticated document, then the unauthenticated document can be determined to have been verified and validated. The threshold level for meeting the document verification process can be determined electronically by the verification application or manually by the user. If the unauthenticated document fails to satisfy the document verification process or if it raises additional questions, meaning that the feature information from the unauthenticated document are not substantially similar to the feature information from the validation documents, the processing device 16, via the verification application, is capable of submitting, via a network, the unauthenticated document to other types of document verification systems. If the authenticity of the unauthenticated document is in question, the user can submit the unauthenticated document for examination and review by the proper document verification authority 18 that can later return the results of the official examination. The document verification authorities 18 include without limitation, international agencies and organizations, commercial agencies and organizations, U.S. government agencies and organizations, and other known security agencies and organizations as shown in FIG. 3.

For security reasons, transactions within the document verification system 10 are secured and encrypted using known systems and methods including without limitation, secure and encrypted routing or transmitting of document features (images and data) between each of the individual devices. Various security implementations can also be accommodated using different hardware and software platforms. Additionally, secure and encrypted routing or transmitting can take place with other document systems outside the document verification system 10 including without limitation, other document applications, servers, application systems, and any other necessary document server, site or application.

Although the invention has been described in detail with reference to several embodiments, additional variations and modifications exist within the scope and spirit of the invention as described and defined in the following claims.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A document verification system, comprising:
a storage device operable to store one or more validation documents;
an acquisition device in communication with the storage device, the acquisition device operable to acquire at least one feature information from one or more unauthenticated documents and at least one feature information from the one or more validation documents; and
a processing device in communication with the acquisition device and the storage device, the processing device operable to receive the at least one feature information from the one or more unauthenticated documents and the at least one feature information from the one or more validation documents.

2. The system of claim 1, wherein the one or more validation documents comprise genuine, counterfeit and exemplars identity documents and financial documents.

3. The system of claim 2, wherein the identity documents and financial documents consist of drivers' licenses, passports, government IDs, social security cards, travel documents, military IDs, birth records, health records, other vital records, currency, credit cards and travelers checks.

4. The system of claim 1, wherein the storage device is further operable to store the one or more unauthenticated documents.

5. The system of claim 1, wherein the storage device is further operable to store the at least one feature information from the one or more unauthenticated documents.

6. The system of claim 1, wherein the storage device is further operable to store the at least one feature information from the one or more validation documents.

7. The system of claim 1, wherein the acquisition device and the processing device are integrated into a single unit.

8. The system of claim 1, wherein the storage device, the acquisition device and the processing device are integrated into a single unit.

9. The system of claim 1, wherein the processing device is further operable to compare the at least one feature information from the one or more unauthenticated documents and the at least one feature information from the one or more validation documents to verify the authenticity of the one or more unauthenticated documents.

10. The system of claim 1, wherein the processing device is further operable to report the authenticity of the one or more unauthenticated documents to a third party.

11. The system of claim 1, wherein the at least one feature information from the one or more unauthenticated documents and the at least one feature information from the one or more validation documents comprise visible features, non-visible features or both.

12. A document verification system, comprising:
a storage device operable to store one or more unauthenticated documents and one or more validation documents;
an acquisition device in communication with the storage device, the acquisition device operable to acquire at least one feature information from the one or more unauthenticated documents and at least one feature information from the one or more validation documents; and
a processing device in communication with the acquisition device and the storage device, the processing device operable to receive and compare the at least one feature information from the one or more unauthenticated documents and the at least one feature information from the one or more validation documents to verify the authenticity of the one or more unauthenticated documents.

13. The system of claim 12, wherein the one or more validation documents comprise genuine, counterfeit and exemplars identity documents and financial documents.

14. The system of claim 13, wherein the identity documents and financial documents consist of drivers' licenses, passports, government IDs, social security cards, travel documents, military IDs, birth records, health records, other vital records, currency, credit cards and travelers checks.

15. The system of claim 12, wherein the storage device is further operable to store the at least one feature information from the one or more unauthenticated documents and the at least one feature information from the one or more validation documents.

16. The system of claim 12, wherein the storage device, the acquisition device and the processing device are integrated in a single unit.

17. The system of claim 12, wherein the processing device is further operable to report the authenticity of the one or more unauthenticated documents to a third party.

18. The system of claim 12, wherein the at least one feature information from the one or more unauthenticated documents and the at least one feature information from the one or more validation documents comprise visible features, non-visible features or both.

19. A method of verifying a document's authenticity, comprising:
acquiring at least one feature information from a first document;
acquiring at least one feature information from a second document; and
comparing the at least one feature information of the first document with the at least one feature information of the second document.

20. The method of claim 19, further comprising providing step-by-step instructions on making the comparison between the at least one feature information of the first document and the at least one feature information of the second document.

21. The method of claim 19, further comprising verifying and reporting the authenticity of the first document based on the comparison by a third party.

22. The method of claim 19, further comprising verifying and reporting the authenticity of the second document based on the comparison by a third party.

23. The method of claim 19, wherein the acquiring at least one feature information from the two documents comprise acquiring visible features, non-visible features or both.
